(19) United States
(12) Patent Application Publication
(10) Pub. No.: US 2024/0062780 A1
(43) Pub. Date: Feb. 22, 2024

(54) NONLINEAR LIGHT ABSORPTION MATERIAL, RECORDING MEDIUM, METHOD FOR RECORDING INFORMATION, AND METHOD FOR READING INFORMATION

(71) Applicant: Panasonic Intellectual Property Management Co., Ltd., Osaka (JP)

(72) Inventors: MASAKO YOKOYAMA, Osaka (JP); KOTA ANDO, Osaka (JP); TERUHIKO SAITO, Osaka (JP); HIDEKAZU ARASE, Hyogo (JP)

(21) Appl. No.: 18/493,230

(22) Filed: Oct. 24, 2023

Related U.S. Application Data
(63) Continuation of application No. PCT/JP2022/012113, filed on Mar. 17, 2022.

(30) Foreign Application Priority Data
May 18, 2021 (JP) 2021-084183

(51) Int. Cl. G11B 7/005; C09B 57/00; G11B 7/24

(52) U.S. Cl. CPC G11B 7/005; C09B 57/00; G11B 7/24

(57) ABSTRACT

A nonlinear light absorption material includes a compound having a nonlinear light absorption property at a wavelength of 390 nm or more and 420 nm or less and represented by the formula (1) as a main component:

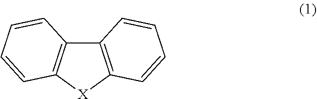

in the formula (1), X is an oxygen atom.

### BACKGROUND

### 1. Technical Field

The present disclosure relates to a nonlinear light absorption material, a recording medium, a method for recording information, and a method for reading information.

### 2. Description of the Related Art

Among optical materials such as light absorption materials, a material having a nonlinear optical effect is called a nonlinear optical material. The nonlinear optical effect means that when a material is irradiated with strong light such as laser light, an optical phenomenon proportional to the square or higher power of the electric field of the irradiation light occurs in the material. Examples of the optical phenomenon include absorption, reflection, scattering, and emission. Examples of the quadratic nonlinear optical effect proportional to the square of the electric field of the irradiation light include second harmonic generation (SHG), a Pockels effect, and a parametric effect. Examples of the tertiary nonlinear optical effect proportional to the cube of the electric field of the irradiation light include two-photon absorption, multi-photon absorption, third harmonic generation (THG), and a Kerr effect. In the present specification, multi-photon absorption such as two-photon absorption may be called nonlinear light absorption. A material that can perform nonlinear light absorption may be called a nonlinear light absorption material. In particular, a material that can perform two-photon absorption may be called a two-photon absorption material.

Many studies have been actively conducted on nonlinear optical materials. In particular, as nonlinear optical materials, inorganic materials from which single crystals can be easily prepared have been developed. In recent years, nonlinear optical materials made of organic materials are expected to be developed. Organic materials, compared to inorganic materials, have not only a high degree of design freedom but also a large nonlinear optical constant. Furthermore, in organic materials, a nonlinear response is performed at a high speed. In the present specification, a nonlinear optical material including an organic material may be called an organic nonlinear optical material.

### SUMMARY

In one general aspect, the techniques disclosed here feature a nonlinear light absorption material comprising a compound that has a nonlinear light absorption property at a wavelength of 390 nm or more and 420 nm or less and that is represented by the following formula (1) as a main component:

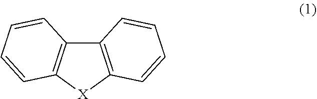

in the formula (1), X is an oxygen atom.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a flow chart of a method for recording information using a recording medium including a nonlinear light absorption material according to an embodiment of the present disclosure; and

FIG. 1B is a flow chart of a method for reading information using a recording medium including a nonlinear light absorption material according to an embodiment of the present disclosure.

### DETAILED DESCRIPTIONS

### Underlying Knowledge Forming Basis of the Present Disclosure

As organic nonlinear optical materials, two-photon absorption materials have received particular attention. The two-photon absorption means a phenomenon that a compound almost simultaneously absorbs two photons and transits to an excited state. As the two-photon absorption, simultaneous two-photon absorption and stepwise two-photon absorption are known. The simultaneous two-photon absorption may be also called non-resonance two-photon absorption. The simultaneous two-photon absorption means two-photon absorption in a wavelength region where there is not one-photon absorption band. The stepwise two-photon absorption may also be called resonance two-photon absorption. In the stepwise two-photon absorption, a compound absorbs a first photon and then further absorbs a second photon to transit to a higher excited state. In the stepwise two-photon absorption, the compound absorbs two photons sequentially.

In the simultaneous two-photon absorption, the amount of light absorbed by a compound is generally proportional to the square of the intensity of the irradiation light and exhibits nonlinearity. The amount of light absorbed by a compound can be used as an index of the efficiency of two-photon absorption. When the amount of light absorbed by a compound exhibits nonlinearity, for example, it is possible to cause absorption of light by the compound at only near the focal point of laser light having a high electric field strength. That is, in a sample including a two-photon absorption material, the compound can be excited at a desired position only. Thus, compounds causing simultaneous two-photon absorption induce a significantly high spatial resolution and are therefore being studied for applications such as a recording layer of a three-dimensional optical memory or a photocurable resin composition for three-dimensional (3d) laser microfabrication.

In two-photon absorption materials, a two-photon absorption cross-section (GM value) is used as an index indicating the efficiency of two-photon absorption. The unit of the two-photon absorption cross-section is GM (10⁻⁵⁰ cm⁴·s·molecule⁻¹·photon⁻¹). A large number of organic two-photon absorption materials having a large two-photon absorption cross-section have been proposed. For example, many compounds having a large two-photon absorption cross-section exceeding 500 GM have been reported (for example, Harry L. Anderson et al, “Two-Photon Absorption and the Design of Two-Photon Dyes”, Angew. Chem. Int., Ed. 2009, Vol. 48, pp. 3244-3266). However, in most of the reports, the two-photon absorption cross-sections have been measured using laser light having a wavelength of longer than 600 nm. In particular, near infrared rays having a wavelength of longer than 750 nm are used as the laser light in some cases.

However, in order to apply a two-photon absorption material to an industrial use, a material expressing a two-photon absorption property when irradiated with laser light having a shorter wavelength is required. For example, in the field of three-dimensional optical memory, laser light having a short wavelength can realize a finer condensed light spot and therefore can improve the recording density of a three-dimensional optical memory. In also the field of three-dimensional (3d) laser microfabrication, laser light having a short wavelength can realize shaping with a higher resolution. Furthermore, in the specification of Blu-ray (registered trademark) disk, laser light having a central wavelength of 405 nm is used. Thus, development of a compound having an excellent two-photon absorption property for light in the same wavelength region as that of laser light having a short wavelength can greatly contribute to the development of the industry.

Furthermore, a light-emitting apparatus that emits an ultrashort pulsed laser with a high intensity is large and tends to be unstable in operation. Accordingly, such a light-emitting apparatus is difficult to be adopted in industrial applications from the viewpoint of versatility and reliability. Considering this situation, in order to apply a two-photon absorption material to an industrial use, a material that expresses a two-photon absorption property even when irradiated with laser light with a low intensity is required.

In a compound having a two-photon absorption property, a relationship between the light intensity and the two-photon absorption property is represented by the following equation (i). In the present specification, the compound having a two-photon absorption property may be referred to as a two-photon absorption compound. The equation (i) is a calculation equation for calculating a reduction −dI in the light intensity when a sample containing a two-photon absorption compound and having a minute thickness dz is irradiated with light having an intensity I. As obvious from the equation (i), the reduction −dI of light intensity is represented by the sum of a term proportional to the first power of the intensity I of incident light on the sample and a term proportional to the square of the intensity I.

$$- \frac{dI}{dz} = α I + {α}^{( 2 )} {I}^{2} \qquad ( i )$$

In the equation (i), α is a one-photon absorption coefficient (cm⁻¹), and α⁽²⁾ is a two-photon absorption coefficient (cm/W). It is recognized from the equation (i) that in a sample, the intensity I of incident light when the one-photon absorption amount and the two-photon absorption amount are equal to each other is represented by α/α⁽²⁾. That is, when the intensity I of incident light is lower than α/α⁽²⁾, one-proton absorption preferentially occurs in the sample. When the intensity I of incident light is higher than α/α⁽²⁾, two-photon absorption preferentially occurs in the sample. Accordingly, there is a tendency that the smaller the value of α/α⁽²⁾ in a sample, the more preferentially two-photon absorption can be expressed by laser light with a low light intensity.

Furthermore, α and α⁽²⁾ can be represented by the following equations (ii) and (iii), respectively. In the equations (ii) and (iii), ε is a molar absorption coefficient (mol⁻¹·L·cm⁻¹); N is the number of molecules of the compound per unit volume of the sample (mol·cm⁻³); N_{A} is an Avogadro constant; σ is a two-photon absorption cross-section (GM); ℏ (h bar) is a Dirac constant (J·s); and ω is the angular frequency of incident light (rad/s).

$$α = 1000 \cdot ln 10 \cdot ε \cdot \frac{N}{{N}_{A}} \qquad ( ii )$$

$${α}^{( 2 )} = \frac{σ N}{ℏ ω} \qquad ( iii )$$

It is recognized from the equations (ii) and (iii) that α/α⁽²⁾ is decided by ε/σ. That is, in order to preferentially express two-photon absorption by laser light having a low light intensity, it is desirable that the ratio of the two-photon absorption cross-section σ to the molar absorption coefficient ε, σ/ε, at the wavelength of the irradiating laser light is large. When the value of ratio σ/ε of a compound at a specific wavelength is large, it is said that the nonlinearity of light absorption at the wavelength is high.

Japanese Patent Nos. 5769151 and 5659189 disclose compounds having large two-photon absorption cross-sections for light with a wavelength of about 405 nm. Japanese Patent No. 5821661 discloses an optical information recording medium that can shorten the writing time when laser light having a wavelength of about 405 nm is used and a compound included in the optical information recording medium. Japanese Patent No. 4906371 discloses a compound exhibiting a large two-photon absorption cross-section when laser light having a wavelength of 800 nm is used.

Japanese Patent Nos. 5769151 and 5821661 describe compounds having a large π electron conjugated system. Furthermore, Japanese Patent No. 5659189 describes a benzophenone derivative having a large π electron conjugated system. However, when the π electron conjugated system of a compound expands, the two-photon absorption cross-section increases, but the peak derived from one-photon absorption tends to shift to the longer wavelength region. In the present specification, a shift of the peak derived from one-photon absorption to the longer wavelength region may be called a long wavelength shift or red shift. As a result of a long wavelength shift of a peak derived from one-photon absorption, the wavelength region where one-photon absorption occurs may partially overlap with the wavelength of excitation light. Incidentally, examples of the wavelength of excitation light include 405 nm defined in the specification of Blu-ray (registered trademark). In a compound, when the one-photon absorption by excitation light is large, the nonlinearity of light absorption tends to decrease. A compound with low nonlinearity of light absorption is unsuitable for a recording layer of a multi-layered three-dimensional optical memory.

Japanese Patent No. 4906371 discloses a fluorene derivative and a polymer thereof as two-photon absorption compounds. However, in the two-photon absorption compound disclosed in Japanese Patent No. 4906371, the two-photon absorption property for light having a wavelength in a short wavelength region is insufficient.

The present inventors have earnestly studied and as a result, have newly found that a compound A represented by a formula (1), a compound B represented by a formula (2), and a compound C represented by a formula (3) described below have a high nonlinear absorption property for light having a wavelength in a short wavelength region, and the nonlinear light absorption material of the present disclosure has been accomplished. Specifically, the present inventors have found that in the compounds A to C, the value of ratio σ/ε of the two-photon absorption cross-section σ to the molar absorption coefficient ε for light having a wavelength in a short wavelength region is large and the nonlinearity of light absorption is high. In the present specification, a short wavelength region means a wavelength region including 405 nm, for example, a wavelength region of 390 nm or more and 420 nm or less.

### Outline of an Aspect according to the Present Disclosure

A nonlinear light absorption material according to a 1st aspect of the present disclosure comprises:
a compound A having a nonlinear light absorption property at a wavelength of 390 nm or more and 420 nm or less and represented by the following formula (1) as a main component. In the formula (1), X is an oxygen atom. The nonlinear light absorption material may further include at least one selected from the group consisting of a compound B represented by the following formula (2) and a compound C represented by the following formula (3). In the formula (2), R¹ and R² are each independently an aliphatic hydrocarbon group.

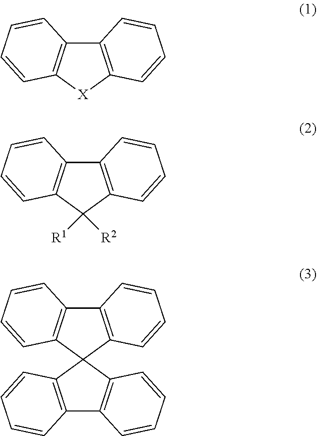

In the nonlinear light absorption material according to the 1st aspect, the ratio of the two-photon absorption cross-section σ to the molar absorption coefficient ε, σ/ε, for light having a wavelength in a short wavelength region is large and the nonlinearity of light absorption tends to be high. Thus, in the nonlinear light absorption material, the nonlinear absorption property for light having a wavelength in a short wavelength region is improved.

For example, in the formula (2), R¹ and R² may be each independently an alkyl group.

For example, in the formula (2), R¹ and R² may be methyl groups.

A recording medium according to a 2nd aspect of the present disclosure comprises:
a recording layer containing the nonlinear light absorption material of the 1st aspect.

According to the 2nd aspect, in the nonlinear light absorption material, the nonlinear absorption property for light having a wavelength in a short wavelength region is improved. A recording medium including such a nonlinear light absorption material can record information with a high recording density.

A recording method for recording information according to a 3rd aspect of the present disclosure, the recording method comprises:
preparing a light source that emits light having a wavelength of 390 nm or more and 420 nm or less; and
collecting the light from the light source and irradiating the recording layer of the recording medium according to the 2nd aspect with the light.

According to the 3rd aspect, in the nonlinear light absorption material, the nonlinear absorption property for light having a wavelength in a short wavelength region is improved. According to the method for recording information using a recording medium including the nonlinear light absorption material, information can be recorded with a high recording density.

A reading method for reading information according to a 4th aspect of the present disclosure is a reading method for reading information recorded by, for example, the recording method according to the 3rd aspect, the reading method comprises:
irradiating the recording layer of the recording medium with light to measure an optical characteristic of the recording layer; and
reading the information from the recording layer.

In a 5th aspect of the present disclosure, for example, in the reading method for reading information according to the 4th aspect, the optical characteristic may be the intensity of light reflected by the recording layer.

According to the 4th or 5th aspect, information can be easily read.

Embodiment of the present disclosure will now be described with reference to the drawings. The present disclosure is not limited to the following embodiments.

### Embodiments

The nonlinear light absorption material of the present embodiment includes a compound A represented by the following formula (1). The nonlinear light absorption material of the present embodiment may further include at least one selected from the group consisting of a compound B represented by the following formula (2) and a compound C represented by the following formula (3):

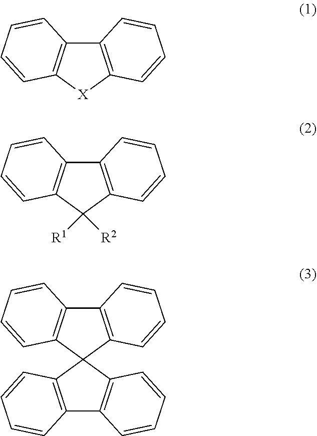

In the formula (1), X is an oxygen atom. The compound A is dibenzofuran of the following formula (4). The nonlinear light absorption material of the present embodiment may further include dibenzothiophene of the following formula (5):

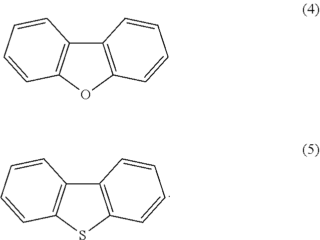

In the formula (2), R¹ and R² are each independently an aliphatic hydrocarbon group. The aliphatic hydrocarbon group may be an aliphatic saturated hydrocarbon group or an aliphatic unsaturated hydrocarbon group. A specific example of the aliphatic saturated hydrocarbon group is an alkyl group. R¹ and R² may be each independently an alkyl group. The alkyl group may be linear, branched, or cyclic. The number of carbon atoms of the alkyl group is not particularly limited and is, for example, 1 or more and 20 or less. The number of carbon atoms of the alkyl group may be 1 or more and 10 or less or 1 or more and 5 or less from the viewpoint of being capable of easily synthesizing the compound B. The solubility of the compound B in a solvent or resin composition can be adjusted by adjusting the number of carbon atoms of the alkyl group. At least one of the hydrogen atoms included in the alkyl group may be substituted by a group including at least one atom selected from the group consisting of N, O, P, and S. Examples of the alkyl group include a methyl group, an ethyl group, a propyl group, a butyl group, a 2-methylbutyl group, a pentyl group, a hexyl group, a 2,3-dimethylhexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an eicosyl group, a 2-methoxybutyl group, and a 6-methoxyhexyl group.

The aliphatic unsaturated hydrocarbon group has an unsaturated bond such as a carbon-carbon double bond and a carbon-carbon triple bond. The number of the unsaturated bonds included in the aliphatic unsaturated hydrocarbon group is, for example, 1 or more and 5 or less. The number of carbon atoms of the aliphatic unsaturated hydrocarbon group is not particularly limited and is, for example, 2 or more and 20 or less and may be 2 or more and 10 or less or 2 or more and 5 or less. The aliphatic unsaturated hydrocarbon group may be linear, branched, or cyclic. Examples of the aliphatic unsaturated hydrocarbon group include a vinyl group and an ethynyl group.

R¹ and R² may be the same as or different from each other. As an example, both R¹ and R² may be methyl groups. That is, specific examples of the compound B include 9,9-dimethylfluorene represented by the following formula (6). Other examples of the compound B include 9,9-diethylfluorene and 9,9-dipropylfluorene.

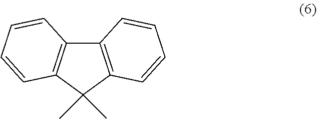

The compounds A to C have an excellent two-photon absorption property for light having a wavelength in a short wavelength region and tend to be low in one-photon absorption. As an example, when the compound A, B, or C is irradiated with light having a wavelength of 405 nm, in the compound, one-photon absorption may be little caused while two-photon absorption is caused.

The two-photon absorption cross-sections of the compounds A to C for light having a wavelength of 405 nm may be higher than 1 GM or may be 10 GM or more. The upper limit of each of the two-photon absorption cross-sections of the compounds A to C is not particularly limited and is, for example, 1000 GM. The two-photon absorption cross-section can be measured by, for example, the Z-scan method described in J. Opt. Soc. Am. B, 2003, Vol. 20, p. 529. The Z-scan method is broadly used as a method for measuring a nonlinear optical constant. In the Z-scan method, a measurement sample is moved along the irradiation direction of a laser beam near the focal point where the beam is focused. On this occasion, the change in the amount of light permeated through the measurement sample is recorded. In the Z-scan method, the power density of incident light changes depending on the position of the measurement sample. Accordingly, when the measurement sample performs nonlinear light absorption, if the measurement sample is located near the focal point of the laser beam, the amount of the transmitted light is attenuated. The two-photon absorption cross-section can be calculated by fitting the change of the amount of transmitted light to a theoretical curve predicted by the intensity of incident light, the thickness of the measurement sample, the concentration of the compound in the measurement sample, and so on.

The molar absorption coefficients of the compounds A to C for light having a wavelength of 405 nm may be 100 mol⁻¹·L·cm⁻¹ or less, 10 mol⁻¹·L·cm⁻¹ or less, 1 mol⁻¹·L·cm⁻¹ or less, or 0.1 mol⁻¹·L·cm⁻¹ or less. The lower limit of the molar absorption coefficients of the compounds A to C is not particularly limited and is, for example, 0.00001 mol⁻¹·L·cm⁻¹. The molar absorption coefficient can be measured by, for example, a method in accordance with the provision of Japanese Industrial Standards (JIS) K0115:2004. The measurement of molar absorption coefficient uses a light source irradiating light with a photon density that hardly causes two-photon absorption by the compounds A to C. Furthermore, in the measurement of molar absorption coefficient, the concentration of the compound as the measurement object is adjusted to 100 mmol/L or more and 2 mol/L or less. This concentration is very high compared to the concentration in a measurement test of the molar absorption coefficient of a light absorption peak. The molar absorption coefficient can be used as an index of one-photon absorption.

In the compounds A to C, the ratio of the two-photon absorption cross-section σ (GM) to the molar absorption coefficient ε (mol⁻¹·L·cm⁻¹), σ/ε, for light having a wavelength in a short wavelength region is large. The ratios σ/ε of the compounds A to C for light having a wavelength of 405 nm may be each 100 or more, 300 or more, 500 or more, 700 or more, or 800 or more. The upper limit of each ratio σ/ε of the compounds A to C is not particularly limited and is, for example, 5000.

When the compounds A to C perform two-photon absorption, the compounds A to C absorb energy about twice that of light applied to the compounds A to C. The wavelength of light having energy about twice that of the light having a wavelength of 405 nm is, for example, 200 nm. When the compounds A to C are irradiated with light having a wavelength of about 200 nm, one-photon absorption may occur in the compounds A to C. Furthermore, in the compounds A to C, one-photon absorption may occur for light having a wavelength near the wavelength region where two-photon absorption is caused.

As described above, the nonlinear light absorption material of the present embodiment includes the compound A. The nonlinear light absorption material may include at least one selected from the group consisting of dibenzofuran, dibenzothiophene, 9,9-dimethylfluorene, and 9,9′-spirobi[9H-fluorene]. The nonlinear light absorption material may include dibenzofuran as the compound A. The nonlinear light absorption material may include 9,9-dimethylfluorene as the compound B. The nonlinear light absorption material may include 9,9′-spirobi[9H-fluorene] as the compound C.

The nonlinear light absorption material of the present embodiment may include the compound A as a main component. The term “main component” means the most abundant component by weight ratio in the nonlinear light absorption material. The nonlinear light absorption material, for example, consists essentially of the compound A. The phrase “consist essentially of” means to exclude other components that change the essential characteristics of the material referred to. However, the nonlinear light absorption material may include impurities in addition to the compound A. The nonlinear light absorption material including the compound A of the present embodiment functions as, for example, a two-photon absorption material.

In general, in order to improve the nonlinearity of light absorption by a compound in a wavelength region of 390 nm or more and 420 nm or less, it is required not only that the compound has a nonlinear light absorption property in the wavelength region but also that the one-photon absorption by the compound in the wavelength region is very small. In adjustment of an optical characteristic of a material with a low concentration of a nonlinear light absorption compound, the optical characteristics of the compound itself may be considered. That is, the molar absorption coefficient in a wavelength region of 390 nm or more and 420 nm or less can be decreased by adopting a compound having a lowest one-photon-allowed state corresponding to the energy of light having a wavelength sufficiently shorter than the wavelength region of 390 nm or more and 420 nm or less and having a small oscillator strength. However, in an industrial use, a material having a high concentration of a nonlinear light absorption compound is required. When the concentration of a nonlinear light absorption compound is high, the compound molecules come close to each other and may be assembled through π-π interaction or the like. The occurrence of the assembly may change the optical characteristics of the compound itself.

Unsubstituted fluorene is a hydrocarbon compound that is nonpolar and has a high planarity. Unsubstituted fluorene corresponds to the compound of the above formula (1) in which X is a methylene group. In the present specification, the unsubstituted fluorene may be simply called fluorene. When the concentration of fluorene in a material is high, fluorene molecules come close to each other and are assembled in various forms. Consequently, multiple new levels are formed at positions with energies lower than the lowest one-photon-allowed state of fluorene itself. Accordingly, tailing of a peak derived from one-photon absorption can be confirmed by measuring the one-photon absorption spectrum of the material including fluorene at a high concentration. In contrast, in the compound A represented by the formula (1) in which X is an oxygen atom or a sulfur atom, the formation of assembly of the compound molecules tends to be suppressed. Therefore, regarding the compound A, even when it is present at a high concentration in the material, tailing of the peak derived from one-photon absorption is suppressed. That is, even if the compound A is present at a high concentration in a material, the molar absorption coefficient for light in a wavelength region of 390 nm or more and 420 nm or less is small, and the nonlinearity of light absorption tends to be high.

In the compound B in which substituents R¹ and R² are introduced into fluorene, steric hindrance is caused. Accordingly, even when the concentration of the compound B in the material is high, the formation of assembly of the compound molecules tends to be suppressed. That is, even when the compound B is present in the material at a high concentration, tailing of the peak derived from one-photon absorption is suppressed. Furthermore, in the compound B, R¹ and R² are aliphatic hydrocarbon groups. Accordingly, a change in the electronic state of fluorene due to the introduction of R¹ and R² is suppressed. That is, in the compound B, the peak derived from one-photon absorption is prevented from shifting to the longer wavelength by introduction of R¹ and R². Consequently, in the compound B, the molar absorption coefficient for light in a wavelength region of 390 nm or more and 420 nm or less is suppressed from increasing. For the reasons above, even when the compound B is present in the material at a high concentration, the molar absorption coefficient for light in a wavelength region of 390 nm or more and 420 nm or less is small, and the nonlinearity of light absorption tends to be high.

The compound C has a large steric hindrance compared to fluorene. Consequently, even when the concentration of the compound C in the material is high, the formation of assembly of the compound molecules tends to be suppressed. That is, even when the compound C is present in the material at a high concentration, tailing of the peak derived from one-photon absorption is suppressed. For the reasons above, even when the compound C is present in the material at a high concentration, the molar absorption coefficient for light in a wavelength region of 390 nm or more and 420 nm or less is small, and the nonlinearity of light absorption tends to be high.

The nonlinear light absorption material of the present embodiment is used in, for example, a device using light having a wavelength in a short wavelength region. As an example, the nonlinear light absorption material of the present embodiment is used in a device using light having a wavelength of 390 nm or more and 420 nm or less. Examples of the device include a recording medium, a shaping device, and a fluorescence microscope. Examples of the recording medium include a three-dimensional optical memory. A specific example of the three-dimensional optical memory is a three-dimensional optical disk. Examples of the shaping device include a three-dimensional (3d) laser microfabrication device such as a 3D printer. Examples of the fluorescence microscope include a two-photon fluorescence microscope. The light used in these devices has, for example, a high photon density near the focal point. The power density near the focal point of the light that is used in the device is, for example, 0.1 W/cm² or more and 1.0×10²⁰ W/cm² or less. This power density near the focal point of light may be 1.0 W/cm² or more, 1.0×10² W/cm² or more, or 1.0×10⁵ W/cm² or more. As the light source of the device, for example, it is possible to use a femtosecond laser such as a titanium sapphire laser or a pulsed laser having a pulse width of from picosecond to nanosecond such as a semiconductor laser.

The recording medium includes, for example, a thin film called a recording layer. In the recording medium, information is recorded in the recording layer. As an example, the thin film as the recording layer includes the nonlinear light absorption material of the present embodiment. That is, from another aspect, the present disclosure provides a recording medium including a nonlinear light absorption material including the compound A above.

The recording layer may further include a polymer compound that functions as a binder, in addition to the nonlinear light absorption material. The recording medium may include a dielectric layer in addition to the recording layer. The recording medium includes, for example, a plurality of recording layers and a plurality of dielectric layers. In the recording medium, a plurality of recording layers and a plurality of dielectric layers may be alternately stacked.

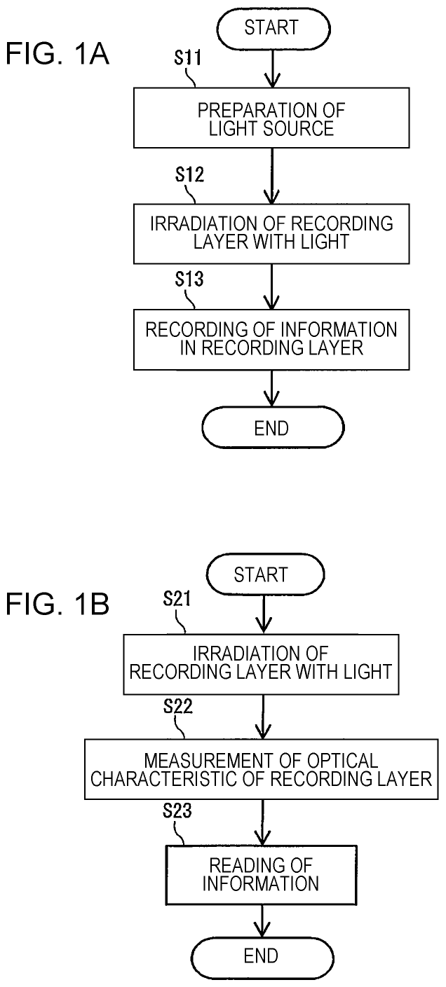

Then, a method for recording information using the recording medium above will be described. FIG. 1A is a flow chart of a method for recording information using the recording medium. First, in step S11, a light source that emits light having a wavelength of 390 nm or more and 420 nm or less is prepared. As the light source, for example, it is possible to use a femtosecond laser such as a titanium sapphire laser or a pulsed laser having a pulse width of from picosecond to nanosecond such as a semiconductor laser. Then, in step S12, the light from the light source is condensed with a lens or the like and is applied to the recording layer of the recording medium. Specifically, the light from the light source is condensed with a lens or the like and is applied to the recording area of the recording medium. This power density near the focal point of the light is, for example, 0.1 W/cm² or more and 1.0×10²⁰ W/cm² or less. This power density near the focal point of light may be 1.0 W/cm² or more, 1.0×10² W/cm² or more, or 1.0×10⁵ W/cm² or more. In the present specification, the recording area means a spot that is present in a recording layer and can record information by irradiation with light.

In the recording area irradiated with light, a physical change or a chemical change occurs. For example, heat is generated when the compound A, B, or C absorbed light turns from the transition state to the ground state. This heat changes the nature of the binder present in the recording area. Consequently, the optical characteristics of the recording area change. The changes are, for example, the intensity of light reflected at the recording area, the reflectance of light at the recording area, the absorptance of light at the recording area, and the refractive index of light at the recording area. In the recording area irradiated with light, the intensity of fluorescent light emitted from the recording area or the wavelength of fluorescent light may also change. Consequently, information can be recorded in the recording layer, specifically, in the recording area (step S13).

Then, a method for reading information using the recording medium will be described. FIG. 1B is a flow chart of a method for reading information using the recording medium above. First, in step S21, the recording layer of the recording medium is irradiated with light. Specifically, the recording area of the recording medium is irradiated with light. The light used in step S21 may be the same as or different from the light used for recording information in the recording medium. Then, in step S22, an optical characteristic of the recording layer is measured. Specifically, an optical characteristic of the recording area is measured. In step S22, for example, as the optical characteristic of the recording area, the intensity of light reflected at the recording area is measured. In step S22, as the optical characteristic of the recording area, for example, the reflectance of light at the recording area, the absorptance of light at the recording area, the refractive index of light at the recording area, or the intensity or wavelength of fluorescent light emitted from the recording area may be measured. Then, in step S23, information is read from the recording layer, specifically, from the recording area.

In the method for reading information, the information recorded area can be located by the following method. First, a specific area of the recording medium is irradiated with light. This light may be the same as or different from the light used for recording information in the recording medium. Then, an optical characteristic of the area irradiated with the light is measured. Examples of the optical characteristic include the intensity of light reflected at the area, the reflectance of light at the area, the absorptance of light at the area, the refractive index of light at the area, the intensity of fluorescent light emitted from the area, and the wavelength of fluorescent light emitted from the area. Whether an area irradiated with light is a recording area or not is judged based on the measured optical characteristic. For example, when the intensity of light reflected at an area is a specific value or less, the area is judged to be a recording area. In contrast, when the intensity of light reflected at an area exceeds a specific value, the area is judged not to be a recording area. Incidentally, the method for judging whether an area irradiated with light is a recording area or not is not limited to the above method. For example, when the intensity of light reflected at an area exceeds a specific value, the area may be judged to be a recording area. Alternatively, when the intensity of light reflected at an area is a specific value or less, the area may be judged not to be a recording area. When an area is judged not to be a recording area, the same procedure is performed for another area of the recording medium. Consequently, a recording area can be located.

The recording method and reading method of information using the recording medium can be performed with, for example, a known recording apparatus. The recording apparatus includes, for example, a light source for irradiating the recording area of a recording medium with light, a measuring device for measuring an optical characteristic of the recording area, and a controller for controlling the light source and the measuring device.

The shaping device performs shaping by, for example, irradiating a photocurable resin composition with light to cure the resin composition. As an example, the photocurable resin composition for three-dimensional (3d) laser microfabrication includes a nonlinear light absorption material of the present embodiment. The photocurable resin composition includes, for example, a polymerizable compound and a polymerization initiator, in addition to the nonlinear light absorption material. The photocurable resin composition may further include an additive such as a binder resin. The photocurable resin composition may include an epoxy resin.

A fluorescence microscope can, for example, irradiate a biological specimen including a fluorescent dye material with light and observe fluorescence emitted from the dye material. As an example, the fluorescent dye material to be added to a biological specimen includes the nonlinear light absorption material of the present embodiment.

### EXAMPLES

The present disclosure will now be described in more detail by examples. Incidentally, the following examples are merely examples, and the present disclosure is not limited to the following examples.

First, compounds of Example 1, Reference Examples 1 to 3, and Comparative Examples 1 to 13 shown in Table 1 were prepared. The compounds of Comparative Examples 1 to 13 are represented by the formulae (7) to (19) below, respectively.

Here, 9,9′-spirobi[9H-fluorene] used as the compound of Reference Example 1 was that manufactured by Tokyo Chemical Industry Co., Ltd., dibenzofuran used as the compound of Example 1 was that manufactured by Sigma-Aldrich Co. LLC, dibenzothiophene used as the compound of Reference Example 2 was that manufactured by Sigma-Aldrich Co. LLC, and 9,9-dimethylfluorene used as the compound of Reference Example 3 was that manufactured by Tokyo Chemical Industry Co., Ltd.

Fluorene used as the compound of Comparative Example 1 was that manufactured by Sigma-Aldrich Co. LLC, 2,7-di-tert-butylfluorene used as the compound of Comparative Example 2 was that manufactured by Tokyo Chemical Industry Co., Ltd., 1-fluorenecarboxylic acid used as the compound of Comparative Example 3 was that manufactured by Tokyo Chemical Industry Co., Ltd., 9-fluorenylmethanol used as the compound of Comparative Example 4 was that manufactured by Tokyo Chemical Industry Co., Ltd., 9-methyl-9H-fluoren-9-ol used as the compound of Comparative Example 5 was that manufactured by Tokyo Chemical Industry Co., Ltd., 9-fluorenone used as the compound of Comparative Example 6 was that manufactured by Tokyo Chemical Industry Co., Ltd., 9,9-dimethylfluorene-2-carboxylic acid used as the compound of Comparative Example 7 was that manufactured by Tokyo Chemical Industry Co., Ltd., 9-(9,9-dimethylfluoren-2-yl)-9H-carbazole used as the compound of Comparative Example 8 was that manufactured by FUJIFILM Wako Pure Chemical Corporation, 9,9-diphenylfluorene used as the compound of Comparative Example 9 was that manufactured by Tokyo Chemical Industry Co., Ltd., and 9,9′-spirobi[9H-fluorene]-2-amine used as the compound of Comparative Example 10 was that manufactured by Tokyo Chemical Industry Co., Ltd.

Hexakis(phenylethynyl)benzene (HPEB) used as the compound of Comparative Example 11 was synthesized according to the method described in K. Konodo et al., J. Chem. Soc., Chem. Commun., 1995, 55-56; and W. Tao, et al., J. Org. Chem., 1990, 55, 63-66. The compound D29 used as the compound of Comparative Example 12 represented by the formula (18) below was synthesized according to the method described in paragraphs [0222] to [0230] of Japanese Patent No. 5659189. The compound if used as the compound of Comparative Example 13 represented by the formula (19) below was synthesized according to the method described in paragraph [0083] of Japanese Patent No. 5821661.

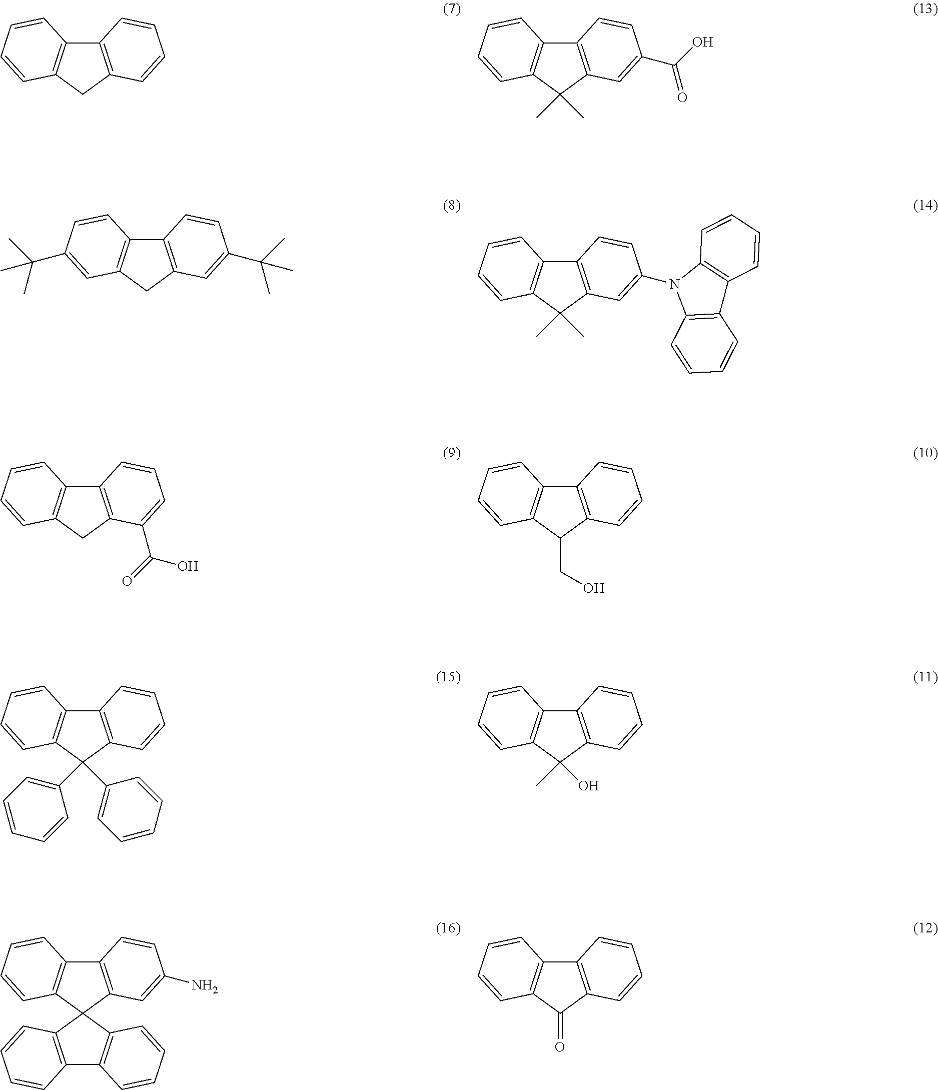

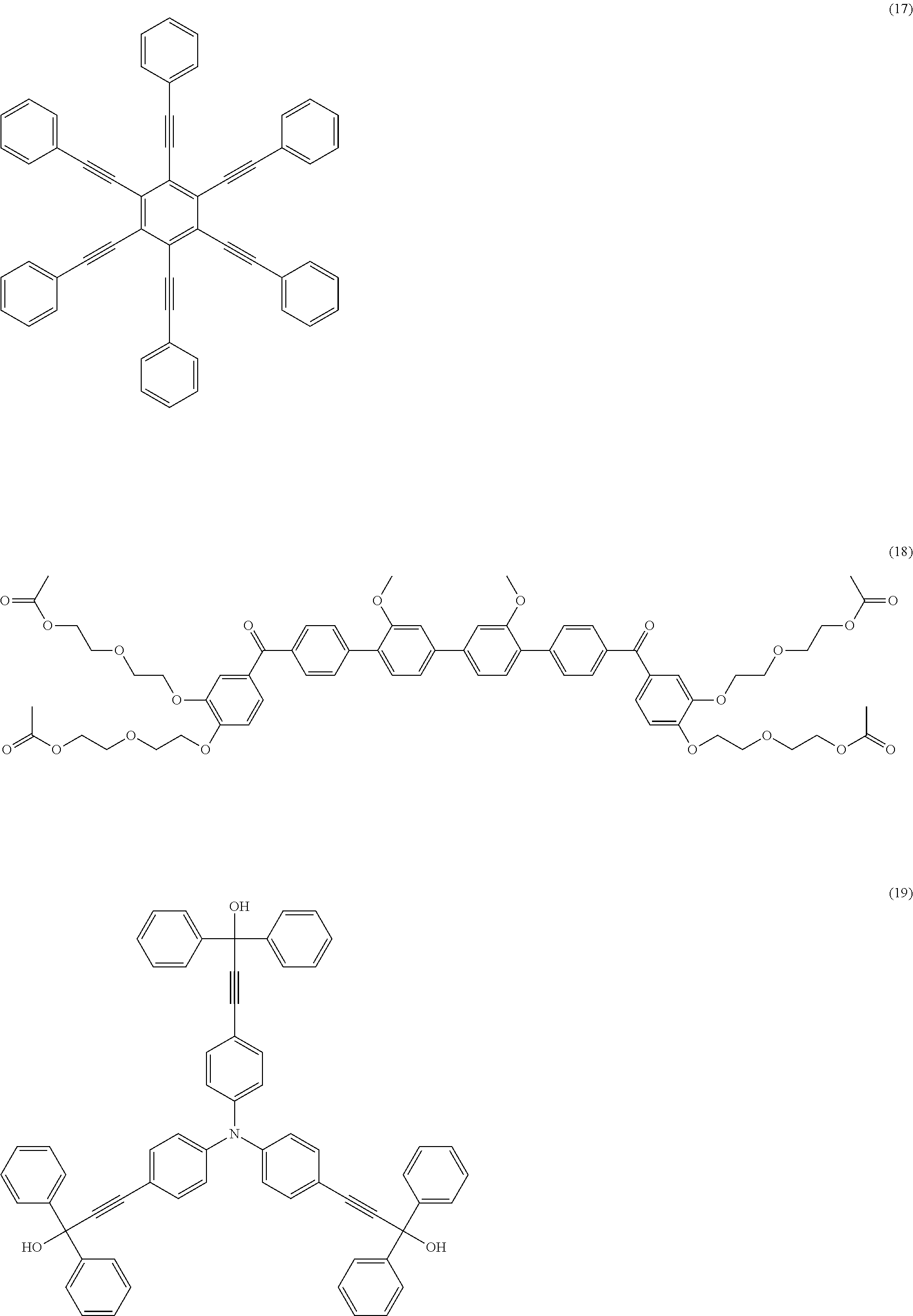

### Measurement of Two-Photon Absorption Cross-Section

The compounds of Example, Reference Examples, and Comparative Examples were each measured for the two-photon absorption cross-section for light having a wavelength of 405 nm. The measurement of the two-photon absorption cross-section was performed using the Z-scan method described in J. Opt. Soc. Am. B, 2003, Vol. 20, p. 529. As the light source for measuring the two-photon absorption cross-section, a titanium sapphire pulsed laser was used. Specifically, each sample was irradiated with the second harmonic titanium-sapphire pulsed laser. The pulse width of the laser was 80 fs. The repetition frequency of the laser was 1 kHz. The average power of the laser was changed within a range of 0.01 mW or more and 0.08 mW or less. The light from the laser was light having a wavelength of 405 nm. Specifically, the light from the laser had a central wavelength of 403 nm or more and 405 nm or less. The light from the laser had a full width at half maximum of 4 nm.

### Measurement of Molar Absorption Coefficient

The compounds of Example, Reference Examples, and Comparative Examples were each measured for the molar absorption coefficient by a method in accordance with the provision of JIS K0115:2004. Specifically, first, as a measurement sample, a solution in which a compound was dissolved in a solvent was prepared. The concentration of the compound in the solution was appropriately adjusted within a range of 100 mmol/L or more and 2 mol/L or less according to the absorbance of the compound as the measurement target at a wavelength of 405 nm. Then, the absorption spectrum of the measurement sample was measured. The absorbance at a wavelength of 405 nm was read from the obtained spectrum. The molar absorption coefficient was calculated based on the concentration of the compound in the measurement sample and the optical path length of the cell used for the measurement.

Table 1 shows the two-photon absorption cross-section σ (GM), molar absorption coefficient ε (mol⁻¹·L·cm⁻¹), and ratio σ/ε obtained by the methods above.

TABLE 1

| | | | Two-photon | | |
|---|---|---|---|---|---|
| | | | absorption | Molar absorption | |
| | Compound | | cross-section | coefficient ε | Ratio |
| | Name | Formula | σ (GM) | (mol⁻¹ · L · cm⁻¹) | σ/ε |
| Reference Example 1 | 9,9′-Spirobi[9H-fluorene] | (3) | 18 | 0.022 | 820 |
| Example 1 | Dibenzofuran | (4) | 5 | 0.007 | 710 |
| Reference Example 2 | Dibenzothiophene | (5) | 5 | 0.043 | 120 |
| Reference Example 3 | 9,9-Dimethylfluorene | (6) | 7 | 0.022 | 350 |
| Comparative Example 1 | Fluorene | (7) | 5 | 0.059 | 85 |
| Comparative Example 2 | 2,7-Di-tert-butylfluorene | (8) | 10 | 0.33 | 30 |
| Comparative Example 3 | 1-Fluorenecarboxylic acid | (9) | 6 | 3.0 | 2 |
| Comparative Example 4 | 9-Fluorenylmethanol | (10) | 8 | 0.40 | 20 |
| Comparative Example 5 | 9-Methyl-9H-fluoren-9-ol | (11) | 5 | 0.17 | 30 |
| Comparative Example 6 | 9-Fluorenone | (12) | 18 | 90 | 0.2 |
| Comparative Example 7 | 9,9-Dimethylfluorene-2- | (13) | 6 | 0.15 | 40 |
| | carboxylic acid | | | | |
| Comparative Example 8 | 9-(9,9-Dimethylfluoren-2-yl)- | (14) | 30 | 7.5 | 4 |
| | 9H-carbazole | | | | |
| Comparative Example 9 | 9,9-Diphenylfluorene | (15) | 12 | 0.16 | 75 |
| Comparative Example | 9,9′-Spirobi[9H-fluorene]-2- | (16) | 37 | 12 | 3 |
| 10 | amine | | | | |
| Comparative Example | Hexakis(phenylethynyl)benzene | (17) | 23000 | 2730 | 10 |
| 11 | (HPEB) | | | | |
| Comparative Example | D29 | (18) | 570 | 35 | 15 |
| 12 | | | | | |
| Comparative Example | 1f | (19) | 380 | 70 | 5 |
| 13 | | | | | |

As obvious from Table 1, in all the compounds of Example 1 and Reference Examples 1 to 3, each corresponding to any of the compounds A, B, and C, the values of ratio σ/ε for light having a wavelength of 405 nm were larger than those of the compounds of Comparative Examples and exceeded 100. This result demonstrates that the compounds A to C each have high nonlinearity of light absorption for light having a wavelength in a short wavelength region and has an improved nonlinear light absorption property.

The compounds of Comparative Examples 1, 4, 5, 6, and 9 are compounds in which R¹ or R² of the formula (2) is not an aliphatic hydrocarbon group. In all these compounds, the value of ratio σ/ε for light having a wavelength of 405 nm was lower than 100. It is inferred that in the compound of Comparative Example 1, since R¹ and R² are hydrogen atoms, the steric hindrance between compound molecules was small, and the compound molecules came close to each other and were assembled in various forms. Consequently, it is inferred that in Comparative Example 1, tailing of a peak derived from one-photon absorption was caused, and the molar absorption coefficient ε was increased, resulting in a small value of the ratio σ/ε. Furthermore, it is inferred that in the compounds of Comparative Examples 4, 5, 6, and 9, the electronic state of fluorene was changed by the substituent introduced in to fluorene, and the HOMO energy was increased or the LUMO energy was decreased. Consequently, it is inferred that the energy necessary for exciting the compound to the lowest one-photon-allowed state was decreased, and the peak wavelength of one-photon absorption was red-shifted. It is inferred that in Comparative Examples 4, 5, 6, and 9, a large increase in the molar absorption coefficient ε for light having a wavelength of 405 nm was caused by the red shift of the peak wavelength of one-photon absorption, and the value of ratio σ/ε was small.

In contrast, the compound B has a structure in which aliphatic hydrocarbon groups are introduced as R¹ and R² into fluorene. In the compound B, assembly of the compound molecules can be suppressed by increasing the steric hindrance without largely changing the electronic state of fluorene. Consequently, it is inferred that in Reference Example 3, even if the concentration of the compound in the measurement sample was high, the molar absorption coefficient ε was small, and the value of ratio σ/ε was large.

The compounds of Comparative Examples 2, 3, 7, 8, and 10 are compounds in which substituents were introduced into the aromatic ring of fluorene. In all these compounds, the value of ratio σ/ε for light having a wavelength of 405 nm was lower than 100. In general, introduction of a substituent into an aromatic ring highly influences the electronic state of fluorene having a condensed ring structure. Accordingly, the introduction of a substituent into the aromatic ring increases the HOMO energy of fluorene or decreases the LUMO energy. In Comparative Examples 2, 3, 7, 8, and 10, it is inferred that the energy necessary for exciting the compound to the lowest one-photon-allowed state was decreased by introducing a substituent into the aromatic ring, and the peak wavelength of one-photon absorption was red-shifted. Consequently, it is inferred that the molar absorption coefficient ε for light having a wavelength of 405 nm was highly increased, and the value of ratio σ/ε was small.

The compounds of Comparative Examples 11 to 13 are compounds that are different from fluorene derivatives. In all these compounds, the value of ratio σ/ε for light having a wavelength of 405 nm was lower than 100. Since the compounds of Comparative Examples 11 to 13 have a large π electron conjugated system, the transition dipole moment is large. Accordingly, in Comparative Examples 11 to 13, the value of two-photon absorption cross-section σ was large. However, in a compound having an extended π electron conjugated system, the peak derived from one-photon absorption tends to shift to the longer wavelength region. It is inferred that in the compounds of Comparative Examples 11 to 13, the wavelength region where one-photon absorption occurs partially overlaps with 405 nm to significantly increase the molar absorption coefficient ε, and consequently, the value of ratio σ/ε was small.

The nonlinear light absorption material of the present disclosure can be used in applications, such as a recording layer of a three-dimensional optical memory or a photocurable resin composition for three-dimensional (3d) laser microfabrication. The nonlinear light absorption material of the present disclosure tends to have a light absorption property exhibiting high nonlinearity for light having a wavelength in a short wavelength region. Accordingly, the nonlinear light absorption material of the present disclosure can achieve a significantly high spatial resolution in application such as a three-dimensional optical memory or a shaping device. The nonlinear light absorption material of the present disclosure can cause preferentially two-photon absorption than one-photon absorption, compared to existing nonlinear light absorption materials, even when irradiated with laser light of a low intensity.

What is claimed is:

1. A nonlinear light absorption material comprising:
a compound having a nonlinear light absorption property at a wavelength of 390 nm or more and 420 nm or less and represented by a formula (1) as a main component: 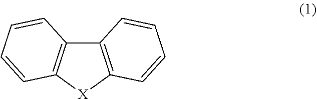
in the formula (1), X is an oxygen atom.

2. A recording medium comprising:
a recording layer including the nonlinear light absorption material according to claim 1.

3. A recording method for recording information, the recording method comprising:
preparing a light source that emits light having a wavelength of 390 nm or more and 420 nm or less; and
collecting the light from the light source and irradiating the recording layer of the recording medium according to claim 2 with the light.

4. A reading method for reading information recorded by the recording method according to claim 3, the reading method comprising:
irradiating the recording layer of the recording medium with light to measure an optical characteristic of the recording layer; and
reading the information from the recording layer.

5. The reading method according to claim 4, wherein
the optical characteristic is intensity of light reflected at the recording layer.
